(19) United States
(12) Patent Application Publication
(10) Pub. No.: US 2007/0179056 A1
(43) Pub. Date: Aug. 2, 2007

(54) Sorbent for removal of trace hazardous air pollutants from combustion flue gas and preparation method thereof

(76) Inventors: Jeom In Baek, Daejeon (KR); Hee Moon Eum, Daejeon (KR); Chong Kul Ryu, Daejeon (KR); Kyung-Ryong Jang, Daejeon (KR); Si Hyun Lee, Daejeon (KR)

Correspondence Address: ST. ONGE STEWARD JOHNSTON & REENS, LLC, 986 BEDFORD STREET, STAMFORD, CT, 06905-5619, US

(21) Appl. No.: 11/341,672

(22) Filed: Jan. 27, 2006

(51) Int. Cl. C01B 31/08

(52) U.S. Cl. 502/400; 502/417

(57) ABSTRACT

Disclosed is a sorbent for the removal of mercury from combustion flue gas and a preparation method thereof. The sorbent includes an activated heavy oil heavy ash impregnated with 0.1-30% by weight of any chemical substance selected from sulfur, iodine, bromine and chlorine. The sorbent is prepared in an economical manner using heavy oil fly ash, industrial waste generated from heavy oil-fired boilers, and has excellent sorption performance for mercury, so that a low concentration of mercury contained in combustion flue gas discharged from large-scale boilers can be removed by injection of a small amount of the sorbent. Thus, the invention can prevent a reduction in the recycling rate of coal fly ash in coal-fired power plants and minimize operation cost.

### FIELD OF THE INVENTION

The present invention relates to the field of sorbents, and more particularly to a sorbent for the removal of mercury and a preparation method thereof. The inventive sorbent is inexpensive, since it is prepared from heavy oil fly ash, industrial waste generated from heavy oil-fired boilers. Also, the inventive sorbent has excellent sorption performance for mercury contained in combustion flue gas, so that it can remove a low concentration of mercury contained in combustion flue gas emitted from large-scale boilers. Thus, according to the present invention, heavy oil fly ash, industrial waste which is disposed of at high costs, can be recycled and converted into a high value-added sorbent, the amount of use of sorbents can be reduced, a reduction in the recycling rate of coal fly ash in coal-fired power plants can be lessened, and the operation cost of sorbent injection process for removing mercury from a large volume of flue gas can be minimized.

### BACKGROUND OF THE INVENTION

Waste contains a trace amount of substances hazardous to the human body, such as mercury or arsenic.

When such waste is burned in a boiler, highly volatile substances (e.g., mercury) among hazardous substances contained in the waste will be partially emitted into the atmosphere to form hazardous air pollutants. Mercury emitted into the atmosphere as described above will cause various diseases when it is accumulated in the human body through natural cyclical processes or food chains. Namely, when mercury emitted into the atmosphere is accumulated in the human body at the top layer of the food chain pyramid in the form of methylmercury during the natural cyclical processes, it will give damage to the nerve system and brain and cause serious disorders in unborn children or infants.

For this reason, in many countries of the world, emission standards for mercury in incineration plants, which are well-known mercury emission sources, are provided and regulated by the law.

Recently, a main source emitting the highest amount of mercury into the atmosphere was known to be coal-fired power plants that burn a large amount of coal to obtain electrical energy. Coal-fired power plants have been excluded from regulation so far, since they emit low concentrations of trace hazardous air pollutants, including mercury; however, the cumulative emission of mercury became non-negligible in view of emission amount, but not emission concentration. Thus, the provision of a solution thereto became necessary. On 15 Mar. 2005, the Environmental Protection Agency (EPA), USA, established rules effective from the year 2010, which regulate the emission of mercury contained in flue gas from coal-fired power plants. Also, in Europe and other countries, a measure to regulate mercury emissions from coal-fired powder plants is being prepared.

Combustion flue gas from large-scale boilers that operate in waste incineration plants, coal-fired power plants, iron mills and the like contains a trace amount of air pollutants hazardous to the human body, including mercury. Of methods for removing these hazardous air pollutants, the most practical technology is a sorption method that uses a sorbent.

When the absorbent is used to remove the hazardous air pollutants, a fixed-bed reactor in which a granular sorbent having a high sorption capacity for pollutants is filled can be used in middle/small-scale incineration plants. However, in large-scale boilers operating in waste incineration plants, coal-fired power plants, iron mills, and the like, the fixed-bed reactor will be difficult to use due to the problem of a pressure drop(loss), and thus a powder sorbent needs to be injected for the removal of the hazardous air pollutants.

As the powder sorbent for removing trace hazardous air pollutants, including mercury, from large-scale boilers provided in waste incineration plants, coal-fired power plants, iron mills, and the like, activated carbon is best considered.

Raw materials for preparing activated carbon are various, including bituminous coal, lignite coal, coconut shells, wood and the like. Activated carbon is prepared by activating these raw materials with steam or carbon dioxide at high temperatures. Activated carbon has a large capacity capable of sorbing pollutants since it has a large specific surface area and many fine pores. Also, it is inexpensive compared to other sorbents.

FIG. 1 shows the structure of the prior system for removing mercury from combustion flue gas using powdered activated carbon. As shown in FIG. 1, the prior system for removing mercury from combustion flue gas using powdered activated carbon has a structure in which powdered activated carbon is injected into combustion flue gas from a boiler 1 using a sorbent injection device, sorbed with mercury from the combustion flue gas and captured in a particulate control device 3.

However, in this system for removing mercury from combustion flue gas by sorbent injection, the injected powdered activated carbon can contacts with mercury in combustion flue gas only for a very short time between the powder activated carbon injection point of the sorbent injection device 2 and the particulate control device 3. For this reason, to increase removal efficiency for mercury contained in large-volume combustion flue gas at low concentrations, a large amount of powder activated carbon must be introduced, and the resulting increase in operation costs becomes the biggest problem in applying the above technology.

Accordingly, to minimize the amount of injection of activated carbon and thus minimize equipment operation costs resulting from the consumption of activated carbon, highly reactive and inexpensive sorbents needs to be developed which can achieve the desired mercury removal rate, even when it is used in small amounts.

Particularly in coal-fired powder plants, since the recycling rate of coal fly ash can also be reduced due to the introduction of activated carbon, a method for preparing an sorbent having high sorption performance is required.

In efforts to obtain sorbents having high sorption performance for mercury compounds, methods are proposed, in which activated carbon prepared from coal, such as bituminouse coal or lignite coal, or material, such as coconut shells, is impregnated with iodine, chlorine, bromine, sulfur or the like, or chemically treated with an aqueous solution of nitric acid or sulfuric acid, to modify the surface of activated carbon. Also, many studies on the optimal conditions to treat activated carbon with these chemicals are conducted. However, activated carbon impregnated with the chemicals is still expensive due to the cost of activated carbon used for chemical impregnation.

And, there are efforts to use waste having high carbon content, such as tires or petroleum cokes as the raw material of activated carbon, to obtain inexpensive activated carbon. However, results sufficient to use as a sorbent for removing mercury in a large volume of combustion flue gas are not yet obtained.

A method for removing mercury from combustion flue gas using a sorbent obtained by treating a carbon-based substrate with bromine was suggested. In this method, as the carbon-based substrate, activated carbon, activated charcoal, activated coke, char, unburned or partially burned carbon, sulfur impregnated PAC or the like is used, and activated carbon is preferably used. When a process of activating the carbon-based substrate is added, the carbon-based substrate is designated as a carbon-based material subjected to steam activation.

U.S. Pat. No. 6,103,205 discloses a process including the steps: subjecting scrap tires or other waste having a significant sulfur content to pyrolysis and activation using carbon dioxide so as to an activated carbon having a sulfur content of at least 3% by weight; filling the activated carbon in a fixed-bed reactor; and passing mercury-containing combustion gas through the fixed-bed reactor while mercury is removed and the mercury-sorbed activated carbon is regenerated for use.

U.S. Pat. Nos. 6,726,888 and 6,863,005 disclose a method for reducing the content of mercury in combustion flue gas by controlling various factors in a boiler combustion zone so as to increase a unburned carbon content, and allowing mercury in combustion flue gas to be sorbed onto the unburned carbon content in a post-combustion zone where the temperature of combustion flue gas is lowered.

U.S. Pat. No. 6,451,094 discloses a method including the steps of adding a raw carbonaceous starting material into a gas stream to convert it into an activated sorbent and allowing the activated sorbent to sorb vapor phase pollutants from the flue gas.

U.S. Pat. No. 6,027,551 discloses a method including injecting unburned carbon separated from fly ash or wood ash so as to sorb mercury compounds from flue gas, and collecting the unburned carbon in a particle control device.

U.S. Pat. No. 5,607,496 discloses a method including using a bed of activated alumina to sorb mercury from combustion flue gas and regenerating mercury-bearing activated alumina. Also, this patent publication discloses using activated alumina to convert elemental mercury into water-soluble oxidized mercury and removing the oxidized mercury in a wet scrubber.

U.S. Pat. No. 5,787,823 discloses a method of increasing removal efficiency for mercury by reintroducing fly ash removed from a particle control device into a flue gas stream in front of the particle control device so as to increase the concentration of fly ash in the flue gas.

U.S. Pat. No. 5,672,323 discloses a method of reducing the introduction of fresh activated carbon by introducing activated carbon into a flue gas stream in front of an electrostatic precipitator so as to sorb mercury from the flue gas and collecting the activated carbon from the electrostatic precipitator and re-injecting the collected activated carbon, as well as a method of increasing mercury removal efficiency by placing an activated carbon bed in a wet flue gas desulfurization tower.

U.S. Pat. No. 4,500,327 discloses a process of removing mercury from a mercury-containing gas by contacting the gas with a sorbent obtained by impregnating an activated carbon having a specific surface area of 200-2000 m²/g with sulfur, bromide or iodide.

However, the above-described sorbents and mercury removal methods developed for the removal of mercury compounds from flue gas, disclosed in said US Patents, have problems in that they are not advantageous either in terms of costs, or in terms of excellence of mercury removal efficiency, as compared to the existing methods of using powdered activated carbon for the removal of mercury. Also, they have problems in that the sorbents must be ground in the form of powder for application to combustion flue gas emitted from large-scale boilers, or an additional process for processing the sorbents is required.

### SUMMARY OF THE INVENTION

Accordingly, the present invention has been made to solve the above problems occurring in the prior art, and an object of the present invention is to provide a sorbent for the removal of mercury from combustion flue gas and a preparation method thereof, in which an inexpensive sorbent having excellent sorption performance for a low concentration of mercury contained in combustion flue gas emitted from large-scale boilers is prepared from heavy oil fly ash, industrial waste generated from heavy oil-fired boilers, whereby heavy oil fly ash which is disposed of at high cost can be recycled and converted into a high value-added sorbent, and at the same time, a reduction in the recycling rate of coal fly ash in coal-fired powder plants can be prevented, and the operation cost of sorbent injection process for removing mercury from a large volume of flue gas can be minimized.

In one embodiment, the present invention provides a sorbent for the removal of mercury from combustion flue gas, the sorbent including an activated heavy oil fly ash impregnated with 1-30% by weight of any one chemical substance selected from the group consisting of sulfur, iodine, bromine and chlorine.

In another embodiment, the present invention provides a method of preparing a sorbent for the removal of mercury from combustion flue gas, the method including the steps of: reacting a heavy oil fly ash with a gas having a carbon dioxide content of 10-100%, at a temperature of 800-1100° C. for 2-12 hours, so as to activate the heavy oil fly ash; and exposing the activated heavy oil fly ash to any one chemical substance selected from vapor-phase sulfur, iodine, bromine and chlorine so as to impregnate the activated heavy oil fly ash with 1-30% by weight of the chemical substance.

In still another embodiment, the present invention provides a method of preparing a sorbent for the removal of mercury from combustion flue gas, the method including the steps of: reacting a heavy oil fly ash with a gas having a carbon dioxide content of 10-100%, at a temperature of 800-1100° C. for 2-12 hours, so as to activate the heavy oil fly ash; bringing the activated heavy oil fly ash into contact with an aqueous solution of any one selected from nitric acid (0.1-63 wt %), sulfuric acid (0.1-98 wt %) and hydrochloric acid (0.1-34 wt %) aqueous solutions; and drying the activated heavy oil fly ash contacted with the aqueous solution.

In the present invention, since heavy oil fly ash, which is classified into industrial waste and disposed of at high cost, is used as a material for mercury sorption, the cost of a raw material for preparing a mercury sorbent is sharply reduced. Also, heavy oil fly ash itself is in the form of powder having a size allowing flying in a flue gas stream, and is subjected to only one process of activation with an gas containing a large amount of carbon dioxide without undergoing a pyrolysis process using inert gas to increase specific surface area. If a process for processing heavy oil fly ash into a mercury sorbent is made in a utility site generating heavy oil fly ash or a utility site requiring the reduction of mercury emission using the mercury sorbent, the flue gas can be used as reaction gas for the activation of heavy oil fly ash and waste heat from the utility can be used in the process for processing heavy oil fly ash. Thus, the preparation cost of the sorbent can be minimized, indicating that the sorbent having the sorption performance equal or higher than that of the existing mercury sorbent can be prepared in an economic manner.

Furthermore, the heavy oil fly ash, which is used as a raw material for the preparation of the mercury sorbent in the present invention, contains a large amount of metal components, and thus contributes to the oxidation of elemental mercury in a process of contacting it with a flue gas containing mercury compounds. Accordingly, in equipment including a wet scrubber from which water-soluble oxidized mercury is removed, the inventive sorbent will show an additional increase in mercury removal efficiency.

### BRIEF DESCRIPTION OF THE DRAWINGS

The above and other objects, features and advantages of the present invention will be more clearly understood from the following detailed description taken in conjunction with the accompanying drawings, in which:

FIG. 1 shows the structure of a system for removing mercury from combustion flue gas using a powdered activated carbon according to the prior art.

FIG. 2 is a flow chart showing a preparation method of preparing a sorbent for the removal of mercury from combustion flue gas, according to one embodiment of the present invention.

FIG. 3 shows the structure of a system for removing mercury from combustion flue gas using a sorbent, according to one embodiment of the present invention.

FIG. 4 shows the structure of a system for testing the mercury removal efficiency of a sorbent, in which the system includes a fixed-bed reactor.

FIG. 5 shows the structure of a system for testing the mercury removal efficiency of a sorbent, in which the system includes a sorbent injection device and an entrained-flow reactor.

FIG. 6 shows the results for testing the mercury removal efficiency of a sorbent for the removal of mercury from gas in the entrained-flow reactor depicted in FIG. 5, according to one embodiment of the present invention.

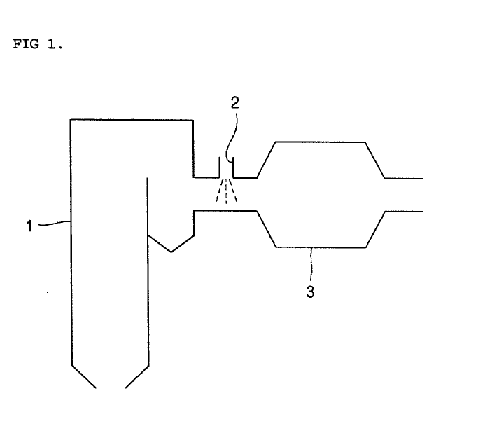

### DETAILED DESCRIPTION OF THE INVENTION

Hereinafter, preferred embodiments of the present invention will be described in detail with reference to the accompanying drawing in order to enable a person skilled in the art to practice the present invention easily.

The operation of the sorbent for the removal of mercury from combustion flue gas and the preparation method thereof, according to the embodiments of the present invention, is as follows.

In the present invention, in order to remove mercury from combustion flue gas discharged from large-size boilers, a powdered sorbent is injected in the rear of the boilers to adsorb the mercury and is removed in an particulate control device, such as electrostatic precipitator and fabric filter. For this purpose, an inexpensive sorbent having high sorption performance for mercury is prepared using heavy oil fly ash, which is disposed of as waste, and the prepared sorbent is applied for the sorption of mercury contained combustion flue gas.

Namely, in the present invention, heavy oil fly ash which is waste generated from heavy oil-fired boilers is activated using an activated carbon preparation process, and the activated heavy oil fly ash is impregnated with a chemical component, such as sulfur, iodine, bromine or chlorine, or treated with acid aqueous solution, such as sulfuric acid aqueous solution, nitric acid aqueous solution or hydrochloric acid aqueous solution, thus modifying the surface of the activated heavy oil fly ash. The activated heavy oil fly ash and the chemically treated inexpensive heavy oil fly ash are used as sorbents for the removal of mercury from combustion flue gas.

The above sorbent is prepared by activating heavy oil fly ash, and exposing the activated heavy oil fly ash to any one chemical substance selected from sulfur, iodine, bromine and chlorine, so as to impregnate the activated heavy oil fly ash with 1-30% by weight of the chemical substance.

Alternatively, the above sorbent is prepared by activating heavy oil fly ash, bringing the activated heavy oil fly ash into sufficient contact with an aqueous solution of any one selected from nitric acid (0.1-63 wt %), sulfuric acid (0.1-98 wt %) and hydrochloric acid (0.1-34 wt %) aqueous solutions, and drying the activated heavy oil fly ash contacted with the aqueous solution.

Hereinafter, the present invention will be described in more detail.

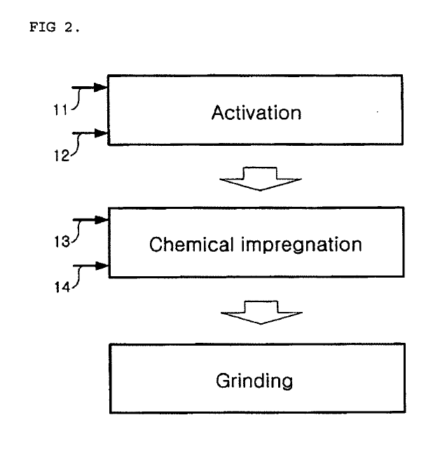

FIG. 2 is a flow chart showing a method of preparing a sorbent for the removal of mercury from combustion flue gas, according to one embodiment of the present invention.

In an activating step of heavy oil fly ash as shown in FIG. 2, a heavy oil fly ash 11, which is collected from a particulate control device provided in the rear of a heavy oil-fired boiler and then discharged as waste, is fed into a reactor, in which it is activated with an activation gas 12 for increasing specific surface area, at a high temperature of about 800-1100° C. for a few hours.

The heavy oil fly ash 11 may be fed intact after being collected from the particulate control device provided in the rear of the heavy oil-fired boiler. Alternatively, it may also be used after being subjected to a process of extracting expensive metal vanadium or nickel therefrom with acid.

The activation gas for activating the heavy oil fly ash 11 is preferably carbon dioxide, and a process byproduct gas containing a large amount of carbon dioxide may also be used. Pure carbon dioxide can be fed using a bombe. A typical example of gas containing a large amount of carbon dioxide is combustion flue gas (having a carbon dioxide content of generally 10-15%), which is produced in a fossil fuel-fired boiler and subjected to a process of purifying air pollutants and then emitted into the atmosphere. To reduce the content of oxygen in the flue gas and to increase the content of carbon dioxide, the flue gas may be used in a mixture with pure carbon dioxide. When a process of using combustion flue gas for the activation of heavy oil fly ash is provided in a utility site generating heavy oil fly ash, such as a heavy oil-fired power plant, or a utility site requiring the reduction of mercury emission, such as a coal-fired power plant operating a large-scale coal-fired boiler to which the present invention is mainly applied, there is an advantage in that the production cost of the sorbent can be reduced, because high-temperature combustion flue gas containing carbon dioxide, waste heat from the utility, and other existing utilities, can be used in the preparation process of the sorbent.

When the activation gas 12 containing a large amount of carbon dioxide is continuously fed to the heavy oil fly ash 11 at a high temperature of about 800-1100° C., the heavy oil fly ash 11 will react with the gas so as to form fine pores in the fly ash and to increase the surface area of the fly ash. The reaction for activation is preferably carried out up to a time point where the weight of the heavy oil fly ash is reduced up to about 40 wt % based on a dry sample to obtain maximum surface area. Heavy oil fly ash collected from a particulate control device in a heavy oil-fired power plant has a specific surface area of mainly 10 m²/g or less, but when it is activated as described above, the specific surface area will increase to about 50 m²/g. In the case of heavy oil fly ash subjected to a process of extracting vanadium or nickel, the specific surface area will increase to 100 m²/g or more, when being treated by the activation process. In a process of reducing mercury in combustion flue gas by the injection of a sorbent, the mercury in the flue gas can be brought into contact with the sorbent only for a few seconds. Thus, the specific surface area of the sorbent does not need to be extremely large, and when the activated heavy oil fly ash is impregnated with a chemical substance to improve mercury sorption performance, the activated heavy oil fly ash will be sufficiently effective even only with the specific surface area thereof.

The heavy oil fly ash having increased specific surface area as a result of the above activation process is then subjected to a process of impregnating a chemical substance.

The processes of impregnating the chemical substance are divided, according to a method of impregnating the chemical substance, into two processes: a process of treating the activated heavy oil fly ash with a vapor-phase chemical substance 13; and a process of treating the activated heavy oil fly ash with a liquid-phase chemical substance 14.

Examples of the vapor-phase chemical substance 13, used to improve the sorption performance of the activated heavy oil fly ash for mercury contained in combustion flue gas, include sulfur, bromine, chlorine and iodine, and examples of the liquid-phase chemical substance 14 include sulfuric acid, hydrochloric acid and nitric acid aqueous solution.

In the process of impregnating the vapor-phase chemical substance, when the temperature of a reactor containing the heavy oil fly ash subjected to the activation process is lowered to the temperature at which the fly ash is to be impregnated with the vapor-phase chemical substance 13, the vapor-phase chemical substance 13 is introduced into the reactor, in which it is brought into contact with the activated heavy oil fly ash. For example, in the case of impregnating sulfur as the vapor-phase chemical substance 13, when the temperature of the reactor is lowered to 500-600° C., sulfur powder is then introduced into the reactor in an amount of 5-30 wt % based on the weight of the heavy oil fly ash, and maintained at 500-600° C. for about 2 hours, in which the sulfur is changed to a vapor phase and then binds to the surface of the activated heavy oil fly ash. When the reactor is rotated such that the sulfur and the activated heavy oil fly ash can uniformly react with each other, the sulfur impregnation efficiency can be increased. The amount of sulfur impregnated on the activated heavy oil fly ash is preferably about 3-5 wt % except for the sulfur content originally contained in the fly ash itself.

In the process of impregnating the liquid-phase chemical substance, the activated heavy fly ash is added to an aqueous solution of any one selected from sulfuric acid (0.1-98 wt %), hydrochloric acid (0.1-34 wt %) and nitric acid (0.1-63 wt %) aqueous solutions, and the mixture is stirred for a few hours, followed by drying. If the activated heavy oil fly ash treated with the acid aqueous solution is used after drying without being subjected to a water washing process, it will show higher mercury removal efficiency, but requires attention because it can cause the problem of corrosion on equipment or a problem in that the sorbent powders are aggregated to make it impossible to inject the powders.

The sorbent impregnated with the chemical substance as described above is subjected to a grinding process, if necessary. Commercially available powdered activated carbon for mercury sorption has an average particle size of less than 20 microns, whereas heavy oil fly ash has an average particle size of about 50-70 microns. Generally, the smaller the particle size of sorbents, the higher the efficiency of the sorbents. Thus, the processed heavy oil fly ash may also be subjected to an additional grinding process in order to increase its mercury removal efficiency. Heavy oil fly ash collected in the particulate control device can be injected without being subjected to an additional grinding process, since it has a size allowing flying in combustion flue gas. Thus, the use of this heavy oil fly ash collected in the particulate control device is advantageous in that it can minimize costs required for a sorbent grinding process in a preparation process of the mercury sorbent.

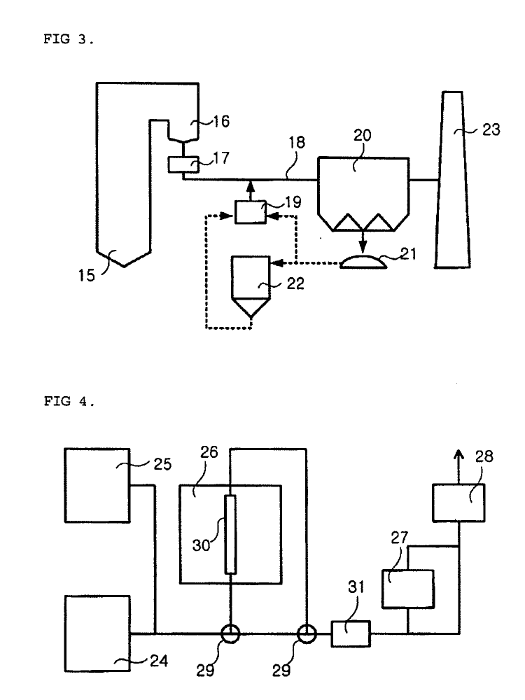

The heavy oil fly ash chemically treated as described above is injected into a combustion flue gas stream containing mercury, using a mercury removal system as shown in FIG. 3, so as to sorb the mercury compounds, and then is collected in a particulate control device.

FIG. 3 shows the structure of a mercury removal system utilizing a sorbent for removing mercury from combustion flue gas, according to one embodiment of the present invention.

When mercury-containing fuel, such as coal, is burned in a boiler 15, the mercury in the fuel is then discharged from the boiler 15 in a vapor phase contained in flue gas, and the combustion flue gas discharged from the boiler 15 is passed through heat recovery units, such as an economizer 16 and an air preheater 17, in which the temperature of the flue gas is lowered to 110-120° C. The vapor-phase mercury in a high-temperature zone in the boiler exists in the form of elemental mercury, but when the temperature of the flue gas is lowered, a portion of the elemental mercury will react with other chemical components in the flue gas so as to change into the form of oxidized mercury.

The chemically treated heavy oil fly ash according to the present invention is injected from a sorbent storage tank 19 into a duckwork 18 through which the combustion flue gas passed through the heat recovery units is passed, such that the fly ash can be uniformly dispersed in the combustion flue gas. The chemically treated heavy oil fly ash injected into the combustion flue gas sorbs vapor-phase mercury including elemental mercury and oxidized mercury, and collected in a particle control device 20, such as an electrostatic precipitator or a fabric filter, along with the fly ash contained in the combustion flue gas. Since the chemically treated heavy oil fly ash collected in the particulate control device is in a state where it has not been sorbed with mercury to saturation, it may, if necessary, also be separated and recycled from fly ash in an unburned carbon separator. If the chemically treated heavy oil fly ash is injected into a flow gas stream, from which fly ash has already been removed, and is collected in the particulate control device, heavy oil fly ash containing no fly ash can be obtained. This heavy oil fly ash is also in a state where it has not been sorbed with mercury to saturation, it can be recycled. The process indicated by a dotted line in FIG. 3 is selectively applicable. Namely, a method of using the chemically treated heavy oil fly ash to remove mercury from flue gas discharged from a large-scale coal-fired boiler is selected from: a process in which the chemically treated heavy oil fly ash is injected into a flue gas stream in the rear of the boiler at a position allowing it to be contacted with mercury compounds for a sufficient time so as to allow it to be uniformly dispersed, thereby sorbing mercury from the flue gas, and then is removed and disposed of in the particulate control device 20; and a process in which a portion of the chemically treated heavy oil fly ash collected in the particulate control device 20 is recycled for use.

On the surface of the chemically treated heavy oil fly ash according to the present invention, reactive groups advantageous for the sorption of mercury are produced, leading to increases in sorption rate and sorption capacity.

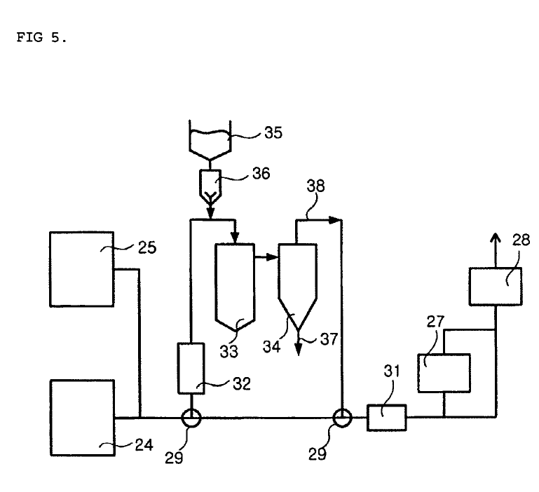

In the present invention, the following activated heavy oil fly ashes were tested for sorption performance for elemental mercury using a system for testing mercury removal efficiency, which is shown in FIG. 4 and equipped with a fixed-bed reactor: activated heavy oil fly ash; activated heavy oil fly ash obtained by adding 1 wt % of sulfur and subjecting the mixture to a impregnation process at 550° C. (amount of actually impregnated sulfur: less than 1 wt %); activated heavy oil fly ash obtained by adding 10 wt % of sulfur and subjecting the mixture to a impregnation process at 550° C. (amount of actually impregnated sulfur: about 2.4-3 wt %); activated heavy oil fly ash treated with 45 wt % nitric acid aqueous solution and washed with water, followed by drying; activated heavy oil fly ash treated with 20 wt % sulfuric acid aqueous solution and dried; activated heavy oil fly ash treated with 30 wt % sulfuric acid aqueous solution and dried; activated heavy oil fly ash treated with 20 wt % sulfuric acid aqueous solution washed with water, followed by drying; and activated heavy oil fly ash treated with 3.5 wt % hydrochloric acid aqueous solution and washed with water, followed by drying.

In the tests, in order to compare mercury sorption performance between activated heavy oil fly ash and chemically treated activated heavy oil fly ash, the following materials were also tested for mercury sorption performance: commercially available activated carbons A and B to which a chemical substance was not added; commercially available activated carbon C impregnated with sulfur; and non-activated heavy oil fly ash.

The above activated heavy oil fly ashes were prepared by activating non-activated heavy oil fly ash with carbon dioxide at 900° C. for 5 hours.

In the test procedure, 60 mg of each of the sorbents having a size of 44-149 μm was filled in a fixed-bed reactor 30, and an air incubator 26 was maintained at a constant temperature of 130° C. In this state, elemental mercury generated from an elemental mercury generator 24 at a constant concentration is carried by nitrogen and diluted with nitrogen from a dilution gas feeder 25 and then introduced into the fixed-bed reactor 30. After sorbing mercury as such, the temperature of gas from the reactor was lowered using a cooler, and a portion of the gas was sampled in a mercury concentration analyzer 27 so as to measure mercury concentrations before and after passage through the fixed-bed reactor, thereby analyzing mercury removal efficiency. After removing the remaining mercury with an activated carbon 28, the gas was vented through an exhaust hood.

In the method for removing mercury from combustion flue gas through sorbent injection, since the time during which mercury can be brought into contact with the sorbent between the sorbent injection point and the particulate control device is only a few seconds, the initial maximum mercury removal efficiency of sorbents is more important than the equilibrium mercury sorption capacity. Thus, in Test Examples of the present invention, we were interested in the initial maximum mercury removal efficiency.

The concentration of mercury in the gas before passing through the fixed-bed reactor 30 filled with 60 mg of the sorbent was measured by feeding the gas into the mercury concentration analyzer 27 using a three-way valve. The mercury removal efficiency of the sorbent filled in the reactor could be obtained by calculating the difference between mercury concentrations before and after passage through the reactor.

The measurement result for initial maximum mercury removal efficiency for each of the sorbents, which has been shown within 1 minute of reaction initiation, is given in Table 1 below.

TABLE 1

| | | | | | Minimum | |
|---|---|---|---|---|---|---|
| | | | | Mercury | mercury | |
| | | Total | Impregnated | concentration | concentration | Maximum |
| | | sulfur | sulfur | (μg/m3) at | (μg/m3) at | mercury |
| Test | | content | content | reactor | reactor | removal |
| Example No. | Sorbents | (wt %) | (wt %) | inlet | outlet | efficiency (%) |
| 1 | Commercially | 0.7 | — | 30.1 | 22.1 | 26.6 |
| | available activated | | | | | |
| | carbon A | | | | | |
| 2 | Commercially | — | — | 29.9 | 23.8 | 20.4 |
| | available activated | | | | | |
| | carbon B | | | | | |
| 3 | Commercially | 9.7 | >9 | 29.1 | 2.4 | 91.7 |
| | available activated | | | | | |
| | carbon C | | | | | |
| | impregnated with | | | | | |
| | sulfur | | | | | |
| 4 | Non-activated heavy | 8.0 | 0 | 28.4 | 23.4 | 17.6 |
| | oil fly ash | | | | | |
| 5 | Activated heavy oil | 5.2 | 0 | 26.4 | 19.6 | 25.8 |
| | fly ash | | | | | |
| 6 | Activated heavy oil | 4.9 | <1 | 31.3 | 10.8 | 65.5 |
| | fly ash obtained by | | | | | |
| | adding 1 wt % sulfur | | | | | |
| | and subjecting the | | | | | |
| | mixture to | | | | | |
| | impregnation | | | | | |
| 7 | Activated heavy oil | 7.8 | 2.5-3.0 | 31.5 | 0.0 | 100 |
| | fly ash obtained by | | | | | |
| | adding 10 wt % sulfur | | | | | |
| | and subjecting the | | | | | |
| | mixture to | | | | | |
| | impregnation | | | | | |
| 8 | Activated heavy oil | — | — | 30.3 | 14.0 | 53.8 |
| | fly ash treated with | | | | | |
| | 45 wt % nitric acid | | | | | |
| | aqueous solution | | | | | |
| | and washed with | | | | | |
| | water, followed by | | | | | |
| | drying | | | | | |
| 9 | Activated heavy oil | — | — | 30.3 | 3.8 | 87.5 |
| | fly ash treated with | | | | | |
| | 20 wt % sulfuric acid | | | | | |
| | aqueous solution | | | | | |
| | and dried | | | | | |
| 10 | Activated heavy oil | — | — | 30.1 | 0.0 | 100 |
| | fly ash treated with | | | | | |
| | 30 wt % sulfuric acid | | | | | |
| | aqueous solution | | | | | |
| | and dried | | | | | |
| 11 | Activated heavy oil | — | — | 30.8 | 19.3 | 37.3 |
| | fly ash treated with | | | | | |
| | 20 wt % sulfuric acid | | | | | |
| | aqueous solution | | | | | |
| | and washed with | | | | | |
| | water, followed by | | | | | |
| | drying | | | | | |
| 12 | Activated heavy oil | — | — | 29.0 | 3.2 | 89.0 |
| | fly ash treated with | | | | | |
| | 3.5 wt % hydrochloric | | | | | |
| | acid aqueous | | | | | |
| | solution and washed | | | | | |
| | with water, followed | | | | | |
| | by drying | | | | | |

As can be seen in Table 1 above, the activated heavy oil fly ash of Test Example 5 showed an initial maximum mercury removal efficiency of 25.8%, which is about 1.5 times higher than 17.6% for the non-activated heavy oil fly ash of Test Example 4, and which is almost equal to 26.6% and 20.4% for the commercially available activated carbons of Test Examples 1 and 2, respectively, which have not been impregnated with sulfur.

The activated heavy oil fly ash of Example 6, obtained by adding 1 wt % sulfur and subjecting the mixture to an impregnation process (amount of actually impregnated sulfur: <1 wt %), showed an initial maximum mercury removal efficiency of 65.5%, which is about 2.5 times higher than the activated heavy oil fly ash of Test Example 5, which has not been impregnated with sulfur.

The activated heavy oil fly ash of Test Example 7, obtained by adding 10 wt % sulfur and subjecting the mixture to an impregnation process (amount of actually impregnated sulfur: 2.5-3 wt %), showed an initial maximum mercury removal efficiency of 100%, even though it had a sulfur impregnation amount significantly smaller than the sulfur impregnation amount of the sulfur-impregnated, commercially available activated carbon of Test Example (about 9%).

The initial maximum mercury removal efficiency of the activated heavy oil fly ash of Test Example 8, which has been immersed in 45 wt % nitric acid aqueous solution for 20 hours and washed with ultrapure water, followed by drying at 110° C. for one day, was 53.8%, which is about 2.1 times higher than that of the chemically untreated, activated heavy oil fly ash of Test Example 5.

The initial maximum mercury removal efficiency of the activated heavy oil fly ash of Test Example 9, which has been stirred in 20 wt % sulfuric acid aqueous solution for 6 hours and dried at 110° C. for one day, was 87.5%, which is about 3.4 times higher than that of the chemically untreated, activated heavy oil fly ash of Test Example 5.

Also, the activated heavy oil fly ash of Test Example 10, which has been stirred in 30 wt % sulfuric acid aqueous solution for 6 hours and dried at 110° C. for 1 day, removed all the fed mercury at the initial stage of reaction. Furthermore, the initial maximum mercury removal efficiency of the activated heavy oil fly ash of Example 11, which has been stirred in 20 wt % sulfuric acid aqueous solution for 2 hours and washed with water, followed by drying at 110° C. for 1 day, was 37.3% which is about 1.45 times higher than that of the chemically untreated, activated heavy oil fly ash of Test Example 5.

In addition, the initial maximum mercury removal efficiency of the activated heavy oil fly ash of Test Example 12, which has been stirred in 3.5 wt % hydrochloric acid aqueous solution for 2 hours and washed with pure water, followed b drying at 110° C. for one day, was 89.0%, which is almost similar to that of the sulfur-impregnated, commercially available activated carbon C of Test Example 3 and is about 3.45 times higher than that of the chemically untreated, activated heavy oil fly ash of Test Example 5.

In the present invention, in order to confirm whether the chemically treated, activated heavy oil fly ash sorbs mercury from gas even in an injection sorption process, the activated heavy oil fly ash, obtained by adding 15 wt % sulfur and subjecting the mixture to an impregnation process at 550° C. (amount of actually impregnated sulfur: about 6 wt %), and the commercially available activated carbon D for mercury removal, were continuously injected into mercury-containing gas in a given amount using an entrained-flow reactor as shown in FIG. 5, and then tested for stabilized mercury removal efficiency.

The test process is as follows. Mercury generated from an elemental mercury generator 24 at a constant concentration was diluted with nitrogen fed from a carrier gas feeder 25, and the gas mixture was fed at a flow rate of 0.5 Nm³/min, and the temperature of the fed gas was elevated with a gas preheater. A sorbent fed from a sorbent storage tank 35 by a screw-type sorbent feeder 36 was mixed with and dispersed in the fed gas in front of the entrained-flow reactor 33 maintained at a constant temperature of 140° C. Then, the mixture was passed through a cyclone 34 separating it into the gas and the sorbent, while the sorbent adsorbed mercury from the gas. The residual time of the sorbent in the gas during a period between the sorbent injection and the recovery of the sorbent from the cyclone 34 was about 1 second, and the weight ratio of the sorbent to mercury was maintained constant since the sorbent from the sorbent feeder 36 was injected in a constant amount. The sorbent 37 separated from the cyclone 34 was removed through the bottom of the system, and the gas 38 from which the sorbent has been removed was vented through the top of the system, and its temperature is lowered using a cooler 31. A portion of the gas was sampled in a mercury concentration analyzer 27 so as to measure mercury concentrations before and after passage through the entrained-flow reactor 33 and the cyclone 34, thereby analyzing mercury removal efficiency. After removing the remaining mercury with activated carbon 28, the gas was vented through an exhaust hood.

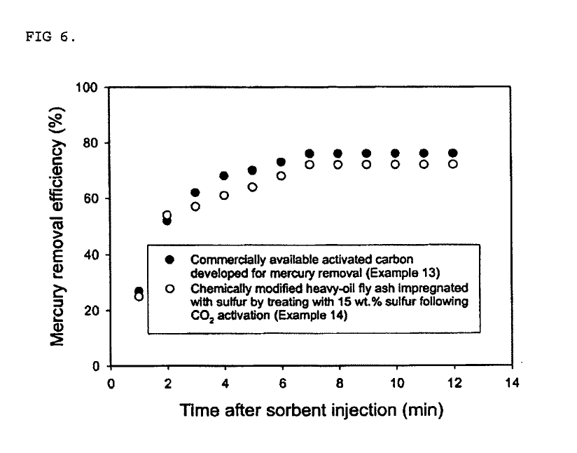

The measurement result of mercury removal efficiency for each of the sorbents, obtained after the mercury sorption reaction in the entrained-flow reactor has been stabilized, is shown in Table 2 below and FIG. 6.

TABLE 2

| | | | | | Mercury | Mercury | |
|---|---|---|---|---|---|---|---|
| | | Total | Impregnated | | concentration | concentration | Mercury |
| | | sulfur | sulfur | | (μg/m3) at | (μg/m3) at | removal |
| Test | | content | content | Sorbent/Hg | reactor | reactor | efficiency |
| Example No. | Sorbent | (wt %) | (wt %) | ratio | inlet | outlet | (%) |
| 13 | Commercially | — | — | 17,300 | 37 | 9 | 76 |
| | available | | | | | | |
| | powdered | | | | | | |
| | activated | | | | | | |
| | carbon D | | | | | | |
| | developed for | | | | | | |
| | mercury | | | | | | |
| | removal | | | | | | |
| 14 | Activated | 11.2 | 6 | 22,000 | 29 | 8 | 72 |
| | heavy oil fly | | | | | | |
| | ash obtained | | | | | | |
| | by adding 15 | | | | | | |
| | wt % sulfur and | | | | | | |
| | subjecting the | | | | | | |
| | mixture to | | | | | | |
| | impregnation | | | | | | |

As can be seen in Table 2 above and FIG. 6, the stabilized mercury removal efficiency of Test Example 14, measured after continuously injecting the activated heavy oil fly ash impregnated with 15 wt % sulfur (amount of actually impregnated sulfur: about 6 wt %) into the mercury-containing flue gas stream, was 72%, which is almost equal to 76% for the commercially available activated carbon D for mercury removal of Test Example 13.

The average particle diameter of the commercially available powdered activated carbon D developed for mercury removal was 15 microns, and the average particle diameter of the sulfur-impregnated, activated heavy oil fly ash was 65 microns. Thus, when the processed heavy oil fly ash is used after grinding into a smaller size, a higher mercury removal efficiency can be obtained.

According to the present invention, the high-performance sorbent capable of sorbing mercury from combustion flue gas is prepared using heavy oil fly ash, waste generated from heavy oil-burning boilers. Thus, the sorbent for the removal of mercury from combustion flue gas can be prepared in an economic manner. Also, the disposal cost of heavy oil fly ash can be reduced and additional economic advantages can be obtained since heavy oil fly ash is marketed after conversion into a high value-added sorbent.

Moreover, when the activated heavy oil fly ash whose specific surface area has been increased through the activated carbon preparation process proposed in the present invention, and the activated heavy oil fly ash whose sorption performance has been increased through chemical treatment, are used as sorbents for the removal of mercury from a large amount of combustion flue gas, the operation cost of a process of removing mercury from a large amount of combustion flue gas by sorbent injection can be reduced since heavy oil fly ash, a raw material for preparing the sorbents, is very inexpensive or available without paying cost.

As described above, according to the present invention, the inexpensive sorbent having excellent sorption performance for trace mercury compounds in combustion flue gas is prepared using heavy oil fly ash, industrial waste generated from heavy oil-burning boilers. When the prepared sorbent is used as a sorbent for the removal of a low concentration of mercury contained in combustion flue gas discharged from large-scale boilers, it can remove the mercury compounds at an excellent efficiency compared to the existing sorbents. Thus, the present invention minimizes cost required for the application of a sorbent injection process for the removal of mercury from a large volume of flue gas. Also, the present invention reduces the disposal cost of heavy oil fly ash and provides additional economic advantages, since heavy oil fly ash, which is disposed of at high cost, is marketed after conversion into a high value-added sorbent.

Although preferred embodiment of the present invention have been described for illustrative purposes, those skilled in the art will appreciate that various modifications, additions and substitutions are possible, without departing from the scope and spirit of the invention as disclosed in the accompanying claims.

What is claimed is:

1. A sorbent for the removal of mercury from combustion flue gas, the sorbent comprising an activated heavy oil fly ash impregnated with 1-30% by weight of any one chemical substance selected from the group consisting of sulfur, iodine, bromine and chlorine.

2. A method of preparing a sorbent for the removal of mercury from combustion flue gas, the method comprising the steps of:
reacting heavy oil fly ash with a gas having a carbon dioxide content of 10-100%, at a temperature of 800-1100° C. for 2-12 hours, so as to activate the heavy oil fly ash; and
exposing the activated heavy oil fly ash to any one chemical substance selected from vapor-phase sulfur, iodine, bromine and chlorine, so as to impregnate the activated heavy oil fly ash with 1-30% by weight of the chemical substance.

3. The method of claim 2, wherein the reaction time for activation is set to a time point where the weight of the heavy oil fly ash is reduced up to about 40 wt % based on a dry sample to obtain maximum surface area.

4. The method of claim 2, which further comprises the step of grinding the heavy oil fly ash impregnated with the chemical substance.

5. The method of claim 2, wherein the heavy oil fly ash is a heavy oil fly ash collected from a particulate control device provided in the rear of a heavy oil-fired boiler.

6. The method of claim 2, wherein the heavy oil fly ash is a heavy oil fly ash subjected to a process of extracting expensive metal vanadium or nickel therefrom with acid.

7. A method of preparing a sorbent for the removal of mercury from combustion flue gas, the method comprising the steps of:
reacting heavy oil fly ash with a gas having a carbon dioxide content of 10-100% at a temperature of 800-1100° C. for 2-12 hours, so as to activate the heavy oil fly ash;
bringing the activated heavy oil fly ash into contact with an aqueous solution of any one selected from nitric acid (0.1-63 wt %), sulfuric acid (0.1-98 wt %) and hydrochloric acid (0.1-34 wt %) aqueous solutions; and
drying the activated heavy oil fly ash contacted with the aqueous solution.

8. The method of claim 7, wherein the reaction time for activation is set to a time point where the weight of the heavy oil fly ash is reduced up to about 40 wt % based on a dry sample to obtain maximum surface area.

9. The method of claim 7, which further comprises the step of grinding the heavy oil fly ash impregnated with the chemical substance.

10. The method of claim 7, wherein the heavy oil fly ash is a heavy oil fly ash collected from a particulate control device provided in the rear of a heavy oil-fired boiler.

11. The method of claim 7, wherein the heavy oil fly ash is a heavy oil fly ash subjected to a process of extracting expensive metal vanadium or nickel therefrom with acid.
